(19) United States
(12) Patent Application Publication
(10) Pub. No.: US 2008/0203336 A1
(43) Pub. Date: Aug. 28, 2008

(54) RADIATION IMAGE DETECTOR

(75) Inventors: Kaku Irisawa, Ashigarakami-gun (JP); Katsutoshi Yamane, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/037,237

(22) Filed: Feb. 26, 2008

(30) Foreign Application Priority Data
Feb. 26, 2007 (JP) 2007-044864

(51) Int. Cl. G01N 23/00

(52) U.S. Cl. 250/591

(57) ABSTRACT

A radiation image detector is constituted by: a first electrode layer, to which negative voltage is applied, and that transmits recording electromagnetic waves bearing radiation image information; a photoconductive layer that generates charges when irradiated by the recording electromagnetic waves transmitted through the first electrode layer; a second electrode layer provided at the side of the photoconductive layer opposite that of the first electrode layer, having a plurality of electrodes for detecting signals corresponding to the charges generated in the photoconductive layer; and an electron transport layer provided between the photoconductive layer and the second electrode layer so as to cover the entire surface of the second electrode layer, formed by an insulating material doped with electron transport molecules.

### BACKGROUND OF THE INVENTION

1. Field of the Invention

The present invention is related to a radiation image detector that records radiation images, by generating electric charges when irradiated by radiation and accumulating the generated electric charges.

2. Description of the Related Art

Various types of radiation image detectors that record radiation images of subjects, by generating electric charges when irradiated by radiation which has passed through the subjects and accumulating the generated electric charges have been proposed and are in practical use, in the field of medicine and the like.

There are two main types of radiation image detectors. One is a direct conversion type, in which radiation is directly converted to electric charges, which are accumulated. The other is an indirect conversion type, in which radiation is converted to light by a scintillator, such as that formed by CdI:Tl, GOS (Gd₂O₂S:Tb), electric charges are generated by the light entering a photoconductive layer, then the generated electric charges are accumulated. There are two main types of radiation image readout methods as well. One is an optical readout method, in which semiconductor materials that generate electric charges when irradiated by light are utilized. The other is an electrical readout method, in which electric charges generated by irradiation of radiation are accumulated in collecting electrodes, then the electric charges are read out by turning electrical switches, such as TFT's (Thin Film Transistors) ON/OFF pixel by pixel.

Japanese Unexamined Patent Publication No. 2006-156555 discloses a radiation image detector of the electrical readout type. An organic film is interposed between electrodes and a charge converting film in this radiation image detector, in order to improve flatness and film properties. Further, carbon particles, metallic particles, and the like are mixed into this organic film, such that the organic film can be used as an electrode. U.S. Pat. No. 5,396,072 also discloses a radiation image detector of the electrical readout type. In this radiation image detector, collecting electrodes are covered by semiconductor films, in order to improve sensitivity and residual image properties.

High dosage radiation is irradiated onto radiation image detectors during imaging operations, and great amounts of electric charges are generated therein. For example, during mammography, radiation at a dosage of approximately 1 R (Roentgen) is irradiated during a single imaging operation. When great amounts of electric charges are generated, electric charges become trapped in non electrode portions between electrodes, at which electric charges are not meant to be accumulated. The trapped electric charges change injected current during voltage application, which becomes a factor that causes the occurrences of image density fluctuations (structural noise). Long periods of time are necessary for the electric charges to become untrapped. During these periods, the amount of trapped electric charges varies from moment to moment. Therefore, the image density fluctuations also vary with time. Even if correction data is obtained on a monthly basis in order to correct the image density fluctuations, it is difficult to predict how the image density fluctuations will occur. Accordingly, image quality properties, such as DQE (Detective Quantum Efficiency) deteriorate.

Provision of a film having conductivity to control charge transport properties may be considered as a means to suppress the aforementioned trapping of electric charges. Conductivity can be increased by mixing carbon particles and metallic particles in an organic film as disclosed in Japanese Unexamined Patent Publication No. 2006-156555, for example. In this method, however, the diameters of the particles which are mixed into the organic film are large. It is therefore difficult to obtain uniform conductivity across the entire film. If local conductivities differ, the image density fluctuations will be emphasized, and the image quality will deteriorate.

In the radiation image detector disclosed in Japanese Unexamined Patent Publication No. 2006-156555, the purpose for providing the organic film is to improve the flatness thereof. Accordingly, there is a tendency for the film to become thick. Particularly in the case that carbon particles are mixed into the film, protrusions and recesses become pronounced, and therefore further coating is performed, resulting in a film thickness of several μm. If the film is thick, the conductivity decreases, resulting in greater image density fluctuations, which is not favorable.

U.S. Pat. No. 5,396,072 discloses defining the polarity of signal charges and doping the semiconductor films with respect to a specific polarity, for example, doping a-Se with Cl to improve the charge transport properties with respect to positive holes. However, doping semiconductors, which inherently have lower resistance than insulators, excessively increases the conductivity thereof, leading to increases in dark current. This results in the image density fluctuations becoming emphasized, deteriorating the image quality. Particularly in the case that an open area ratio (to be defined later) is small, electrical field concentration at the electrodes will become great, further deteriorating the image quality.

### SUMMARY OF THE INVENTION

The present invention has been developed in view of the foregoing circumstances. It is an object of the present invention to provide a radiation image detector capable of suppressing image density fluctuations, to improve image quality.

A radiation image detector of the present invention is constituted by:

a first electrode layer, to which negative voltage is applied, and that transmits recording electromagnetic waves bearing radiation image information;

a photoconductive layer that generates charges when irradiated by the recording electromagnetic waves transmitted through the first electrode layer;

a second electrode layer provided at the side of the photoconductive layer opposite that of the first electrode layer, having a plurality of electrodes for detecting signals corresponding to the charges generated in the photoconductive layer; and

an electron transport layer provided between the photoconductive layer and the second electrode layer so as to cover the entire surface of the second electrode layer, formed by an insulating material doped with electron transport molecules.

Here, the “electron transport layer provided between the photoconductive layer and the second electrode layer so as to cover the entire surface of the second electrode layer, formed by an insulating material doped with electron transport molecules” means that the electron transport layer covers the entire surface of the second electrode layer that faces the photoconductive layer. The surface of the second electrode layer opposite the photoconductive layer is not necessary covered by the electron transport layer.

The electron transport molecules to be doped in the radiation image detector of the present invention may be nanocarbon molecules.

In the present specification, “nanocarbon molecules” are defined to include all molecules in which carbon atoms are connected spherically or cylindrically, having diameters on the order of nanometers. Examples of “nanocarbon molecules” include fullerenes such as C₆₀ and C₇₀, and carbon nanotubes. Other examples of “nanocarbon molecules” include C₇₆, C₇₈, C₈₄, carbon nanofoams, and carbon nanosheets. The “nanocarbon molecules” also include those in which substances other than carbon atoms, such as metallic atoms, are contained within the spherically or cylindrically connected carbon atoms.

The radiation image detector of the present invention may further be provided with: a readout photoconductive layer provided between the photoconductive layer and the second electrode layer that generates charges when irradiated by readout light. Alternatively, the radiation image detector of the present invention may be of a configuration, wherein: the electrodes of the second electrode layer collect the charges which are generated in the photoconductive layer; and the second electrode layer is further equipped with integrating capacitors for accumulating the charges collected by the electrodes, and switching elements for reading out the charges accumulated within the integrating capacitors.

Here, “readout light” refers to any electromagnetic wave that enables movement of electric charges within electrostatic recording devices, to realize electrical readout of latent images. Specific examples include light and radiation.

The radiation image detector of the present invention is provided with the electron transport layer, which is constituted by the insulator doped with electron transport molecules having small particle sizes. The electron transport layer is provided to cover the entire surface of the second electrode layer, which has the plurality of electrodes. According to this configuration, highly uniform conductivity is imparted to the electron transport layer, while enabling the electron transport layer to be formed thin, with a favorable level of conductivity. Therefore, trapping of electrical charges in non electrode portions can be reduced and image density fluctuations can be suppressed, thereby improving image quality.

### BRIEF DESCRIPTION OF THE DRAWINGS

FIG. 1 is a perspective view of a radiation image detector according to a first embodiment of the present invention.

FIG. 2 is a sectional view of the radiation image detector of FIG. 1 taken along line A-A of FIG. 1.

FIG. 3A is a graph for explaining a structural change rate of the radiation image detector according to the first embodiment.

FIG. 3B is a graph for explaining a structural change rate of the radiation image detector according to the first embodiment.

FIG. 4 is a schematic view that illustrates the construction of a radiation image detector according to a second embodiment of the present invention.

### BEST MODE FOR CARRYING OUT THE INVENTION

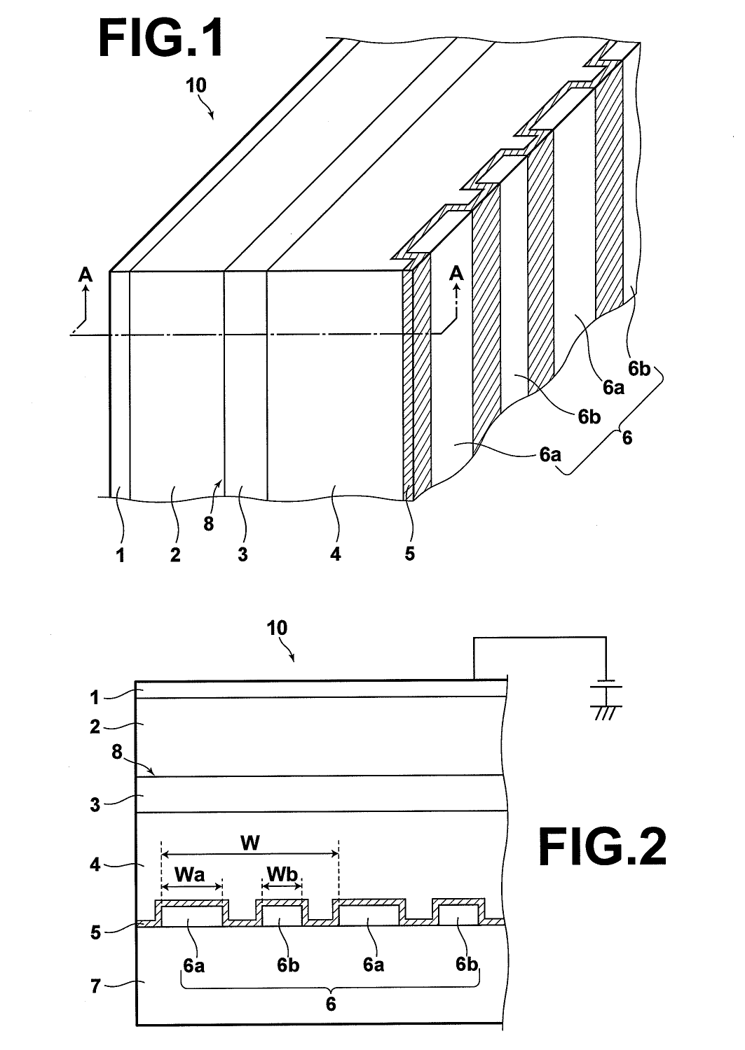

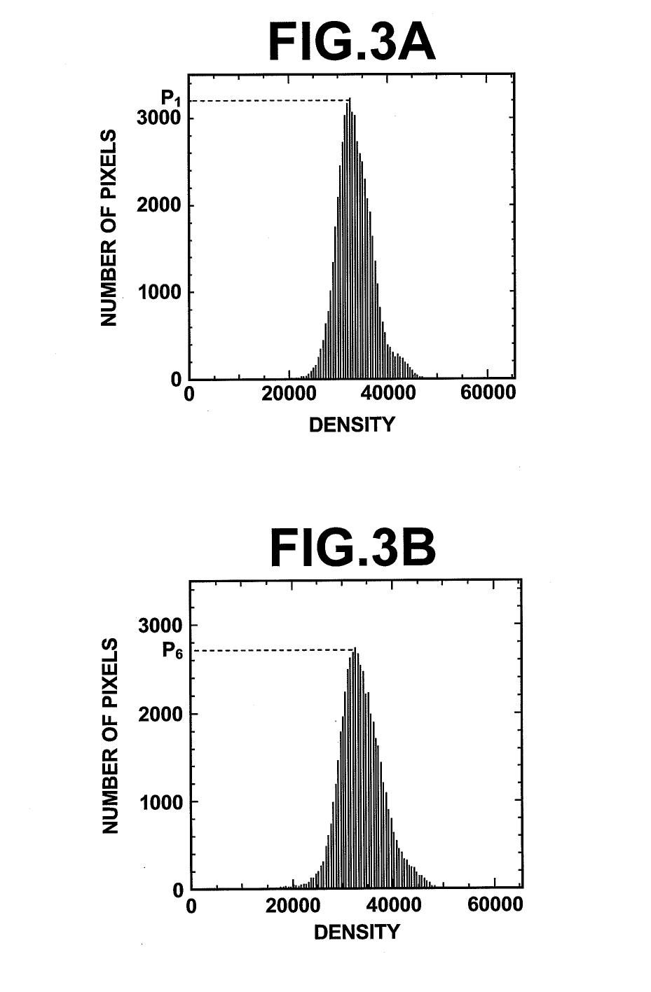

Hereinafter, embodiments of the present invention will be described with reference to the attached drawings. FIG. 1 is a perspective view of a radiation image detector 10 according to a first embodiment of the present invention, and FIG. 2 is a sectional view of the radiation image detector 10 taken along line A-A of FIG. 1.

The radiation image detector 10 is formed by stacking: a first electrode layer 1, to which negative voltage is applied, and that transmits recording electromagnetic waves bearing radiation image information; a recording photoconductive layer 2 that generates charges when irradiated by the recording electromagnetic waves transmitted through the first electrode layer 1; a positive hole transport layer 3, which functions as an insulator with respect to latent image charges (electrons) and as a conductor with respect to charges (positive holes) of a polarity opposite that of the latent image charges, from among the electric charges generated by the recording photoconductive layer 2; a readout photoconductive layer 4 that generates charges when irradiated by readout light; an electron transport layer 5 formed by an insulating material doped with electron transport molecules; and a second electrode layer 6 having a plurality of electrodes for detecting signals corresponding to the charges generated in the recording photoconductive layer 2; in this order. Further, an accumulating section 8, at which electric charges generated within the recording photoconductive layer 2 are accumulated, is formed between the recording photoconductive layer 2 and the positive hole transport layer 3. Note that the above layers are formed on a substrate 7 starting with the second electrode layer 6. However, the substrate 7 is omitted from FIG. 1.

The first electrode layer 1 may be formed by any material as long as it transmits radiation. Examples of such materials include: NESA film (SnO₂); ITO (Indium Tin Oxide); IDIXO (Idemitsu Indium X-metal Oxide, by Idemitsu K. K.), which is an amorphous light transmissive oxide film; at thicknesses of 50 nm to 200 nm. Further examples of such materials include Al and Au at thicknesses of 100 nm.

The recording photoconductive layer 2 may be formed by any material as long as it generates electric charges by being irradiated with radiation. A material having a-se (amorphous selenium), which has a comparatively high quantum efficiency with respect to radiation and high dark resistance, as its main component may be used. The thickness of the recording photoconductive layer 2 may be in a range from 100 μm to 1000 μm.

It is preferable for the positive hole transport layer 3 to have a great difference between the motility of electric charges which are charged on the first electrode layer 1 during recording of radiation images, and the motility of electric charges of the opposite polarity (for example, a difference of 10² or greater, and preferably 10³ or greater). Examples of materials for the positive hole transport layer 3 include organic compounds, such as: Poly N vinyl carbazole (PVK); N,N′-diphenyl-N,N′-bis(3-methylphenyl)-[1, 1′biphenyl]-4,4′-diamine (TPD); and discotic liquid crystals; and semiconductor materials, such as a-Se doped with TPD polymer dispersants (polycarbonate, polystyrene, PVK) and Cl at 10 ppm to 200 ppm.

The readout photoconductive layer 4 may be formed by any material as long as it exhibits conductivity when irradiated with readout light. The material is preferably a photoconductive substance having at least one of: a-Se; Se—Te; Se—As—Te; nonmetallic phtalocyanine; metallic phtalocyanine; MgPc (magnesium phtalocyanine); VoPc (phase II of vanadyl phtalocyanine); and CuPc (copper phtalocyanine) as its main component. The readout photoconductive layer 4 may be formed to be of a thickness within a range of 0.1 μm to 10 μm.

The electron transport layer 5 is provided to reduce trapping of electrical charges at locations other than the electrodes of the second electrode layer 6. The electron transport layer 5 is constituted by an insulator doped with electron transport molecules. Examples of materials for the insulator include: PC (polycarbonate); organic acrylic resin; polyimide; BCB(benzo-cyclo-butane); PVA (polyvinyl alcohol); acrylic; polyethylene; and polyether imide, for example. Nanocarbon molecules, for example, may be employed as the electron transport molecules. Examples of nanocarbons include: fullerenes such as C₆₀ and C₇₀, C₇₆, C₇₈, and C₈₄; carbon nanotubes, carbon nanofoams, and carbon nanosheets. The amount of nanocarbon molecules to be doped in the insulator may be within a range of 5 wt % to 35 wt %, and the thickness of the electron transport layer 5 is preferably within a range of 0.05 μm to 0.5 μm. It is preferable for the conductivity of the electron transport layer 5 to be within a range of 10¹¹ Ω·cm to 10¹³ Ω·cm.

The second electrode layer 6 is constituted by a plurality of electrodes, for detecting signals corresponding to the electric charges generated in the recording photoconductive layer 2. Specifically, the second electrode layer 6 has a plurality of charge pair generating first linear electrodes 6a and a plurality of charge pair non generating second linear electrodes 6b. The first linear electrodes 6a and the second linear electrodes 6b are provided alternately and substantially parallel to each other, with predetermined intervals therebetween.

The first linear electrodes 6a may be formed by any material, as long as the material is transmissive with respect to the readout light and is conductive. Examples of materials for the first linear electrodes 6a include ITO and IDIXO, at a thickness within a range of 0.1 μm to 1 μm. Alternatively, the first linear electrodes 6a may be formed by metals such as Al and Cr, at thicknesses that transmit the readout light (for example, approximately 10 nm).

The second linear electrodes 6b may be formed by any material, as long as the material is not transmissive with respect to the readout light and is conductive. Examples of materials for the second linear electrodes 6b include metals such as Al and Cr, at thicknesses that do not transmit the readout light (for example, approximately 100 nm).

Note that in this radiation image detector that employs the optical readout method, the width of each first linear electrode 6a, the width of each second linear electrode 6b, and the width of a single cycle are denoted as Wa, Wb, and W, respectively. An open area ratio is defined as: (Wa+Wb)/W. The open area ratio represents the percentage of the area of the radiation image detector which is covered by the electrodes when viewed from the stacking direction of the layers. Commonly, the open area ratio decreases as the width W of a single cycle becomes smaller.

The substrate 7 may be formed by any material, as long as it is transmissive with respect to the readout light. Examples of such materials include glass and organic polymers.

In the radiation image detector 10 of the present embodiment having the construction described above, the charge transport characteristics are controlled by providing the electron transport layer 5, which is an insulator doped with electron transport molecules, so as to cover the entire surface of the second electrode layer 6. The electron transport substance is provided in molecule size as dopants. Therefore, a highly uniform conductivity is obtained across the electron transport layer 5, and the electron transport layer 5 can be formed with a thin film thickness, to enable obtainment of a favorable conductive characteristics. Thereby, trapping of electric charges at non electrode portions can be reduced, image density fluctuations can be suppressed, and image quality can be improved.

In contrast, the conventional method uses metal or carbon particles to impart conductivity to an insulating film, as disclosed in Japanese Unexamined Patent Publication No. 2006-156555. This method causes local variances in current density to occur, and the film thickness becomes thick, on the order of several μm, which causes the variances to increase, and is not favorable.

Particularly in the case that a-Se is used as the material for the readout photoconductive layer 4, if current flows through a small region, for example, a portion at which a conductive particle is present, crystallization occurs at that region, and a fluctuation in image density is generated. In the case that photoconductive films, which are deteriorated by current, other than a-Se are used, if current flows through a small region, for example, a portion at which a conductive particle is present, deterioration occurs at that region, and a fluctuation in image density is generated. Accordingly, it is necessary to uniformly suppress the conductivity, that is, current flow, across the entire surface of the photoconductive film. The electron transport layer of the radiation image detector of the present embodiment, which is uniformly doped with the molecule sized electron transport substance and is of the minimum necessary thickness, enables suppression of image density fluctuations and improvement of image quality.

Next, an example of the operation of the radiation image detector 10 will be described. A high voltage source applies a negative biasing voltage to the first electrode layer 1 of the radiation image detector 10, to form an electrical field between the first electrode layer 1 and the second electrode layer 6. Radiation is irradiated from a radiation source, such as an X-ray source, onto a subject in this state. The radiation, which has passed through the subject and bears a radiation image thereof, is irradiated onto the radiation image detector 10 from the side of the first electrode layer 1.

The radiation passes through the first electrode layer 1 and is irradiated onto the recording photoconductive layer 2. Thereby, charge pairs corresponding to the amount of radiation are generated in the recording photoconductive layer 2. Among the generated charge pairs, positive electric charges (positive holes) move toward the first electrode layer 1, combine with the negative charges which have been injected by the high voltage source, and disappear. Meanwhile, negative electric charges (electrons) from among the generated charge pairs move toward the second electrode layer 6 along the electrical field distribution formed by the application of the biasing voltage. The electrons are accumulated as latent image charges in the accumulating section 8 at the interface between the positive hole transfer layer 3 and the recording photoconductive layer 2. The amount of the latent image charges is substantially proportionate to the dosage of the irradiated radiation, and represents the radiation image.

If high dosage radiation is irradiated at this time, passage of negative charges through the positive hole transport layer 3 and the readout photoconductive layer 4 from the accumulating section 8 may occur. In radiation image detectors which do not have the electron transport layer 5, or in radiation image detectors which merely have an insulating layer instead of the electron transport layer 5, the negative charges become trapped between the first linear electrodes 6a and the second linear electrodes 6b, thereby causing image density fluctuations to appear. However, the radiation image detector 10 of the present embodiment is equipped with the electron transport layer 5 having the construction described above. Accordingly, trapping of negative charges is reduced, and the occurrence of image density fluctuations can be suppressed.

When the radiation image which has been recorded on the radiation image detector 10 is read out, readout light is irradiated from the side of the substrate 7 in a state in which the first electrode layer 1 is grounded. The readout light, which is linear and extends in a direction perpendicular to the longitudinal direction of the linear electrodes 6 of the second electrode layer 6, is scanned across the entire surface of the radiation image detector 10 in the longitudinal direction of the linear electrodes 6. The irradiation of the readout light causes charge pairs to be generated in the readout photoconductive layer 4 at positions corresponding to the scanning positions of the readout light. Positive charges from among the charge pairs move toward the latent image charges at the accumulating section 8, combine with the latent image charges, and disappear. Meanwhile, negative charges from among the charge pairs move toward the positive charges which are charged in the first linear electrodes 6a of the second electrode layer 6, combine with the positive charges, and disappear.

The above combinations of negative charges and positive charges cause electric currents to flow through current detecting amplifiers (now shown). The currents are integrated and detected as image signals, to perform readout of image signals corresponding to the radiation image.

Next, Examples of the radiation image detector 10 having the aforementioned construction and Comparative Examples will be described.

### EXAMPLE 1

A radiation image detector having a width W of a single cycle of 50 μm and an open area ratio of 60% was provided with an electron transport layer 5, formed by a polycarbonate film doped with C60 at 5 wt % at a thickness of 200 nm by a dip coating method. The structural change rate was 15% after 6000 measurements, during which negative voltage was applied to the first electrode layer of the radiation image detector.

Here, the “structural change rate” refers to the following value. Histograms, in which gradations of images which are read out without irradiating X-rays are multiplied by 500 and in which the horizontal axis represents density and the vertical axis represents the number of pixels, are obtained at a first measurement and a 6000th measurement (the approximate number of imaging operations for a single month). The difference between a number of pixels P₁ at the peak of a distribution within the histogram obtained for the first measurement and a number of pixels P₆₀₀₀ at the peak of a distribution within the histogram obtained for the 6000th measurement. That is, the structural change rate is defined as: (P₁−P₆₀₀₀)/P₁·100 (%). Ideally, it is desirable for all of the pixels to assume a single value. However, the density differs among each pixel. Therefore, the distribution is recorded to perform image correction to approach an ideal state, and a distribution that does not vary over repeated imaging operations is necessary in order to realize accurate correction. Accordingly, it is desirable for the structural change rate to be as close to 0% as possible.

### EXAMPLE 2

A radiation image detector having a width W of a single cycle of 50 μm and an open area ratio of 60% was provided with an electron transport layer 5, formed by a polycarbonate film doped with C60 at 5 wt % at a thickness of 200 nm by a spin coating method. The structural change rate was 5% after 6000 measurements performed in the same manner as for Example 1. It is thought that fluctuations in film thickness were reduced compared to Example 1, due to use of the spin coating method.

### COMPARATIVE EXAMPLE 1

A radiation image detector having a width W of a single cycle of 50 μm and an open area ratio of 60% was not provided with an electron transport layer 5 as Comparative Example 1. The structural change rate was 35% after 6000 measurements performed in the same manner as for Example 1.

### COMPARATIVE EXAMPLE 2

A radiation image detector having a width W of a single cycle of 50 μm and an open area ratio of 60% was provided with a polycarbonate film formed at a thickness of 200 nm by a dip coating method, instead of the electron transport layer 5. The structural change rate was 39% after 6000 measurements performed in the same manner as for Example 1.

As can be understood from the structural change rates of Example 1, Example 2, Comparative Example 1, and Comparative Example 2, improvements in the structural change rate were observed by providing the electron transport layer 5, formed polycarbonate film, which is an insulator, doped with C60 as electron transport molecules.

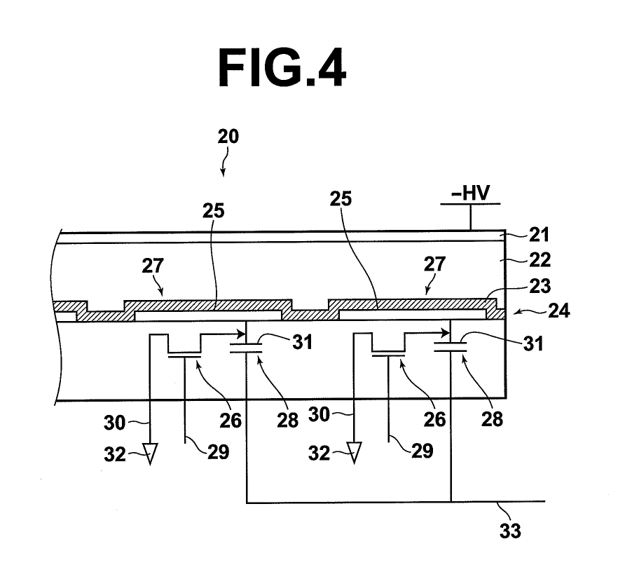

Next, a radiation image detector 20 according to a second embodiment of the present invention will be described. FIG. 4 is a schematic view that illustrates the construction of the radiation image detector 20.

The radiation image detector 20 of the second embodiment employs the electrical readout method. The radiation image detector 20 is formed by stacking: a first electrode layer 21, to which negative voltage is applied, and that transmits recording electromagnetic waves bearing radiation image information; a photoconductive layer 22 that generates charges when irradiated by the recording electromagnetic waves transmitted through the first electrode layer 1; an electron transport layer 23 formed by an insulating material doped with electron transport molecules; and a second electrode layer 24 having a plurality of electrodes for collecting the charges generated in the photoconductive layer 22; in this order, as illustrated in FIG. 4.

The first electrode layer 21 is formed by a low resistance conductive material, such as Au. A high voltage source, for applying negative biasing voltage, is connected to the first electrode layer 21.

The photoconductive layer 22 has electromagnetic wave conductivity, and generates charges therein when irradiated by radiation. The photoconductive layer 22 may be a non crystalline a-Se film having selenium as its main component at a thickness of 100 μm to 1000 μm, for example.

The electron transport layer 23 is provided to reduce trapping of electrical charges at locations other than the electrodes of the second electrode layer 24. The electron transport layer 23 is constituted by an insulator doped with electron transport molecules. Examples of materials for the insulator include: PC (polycarbonate) ; organic acrylic resin; polyimide; BCB(benzo-cyclo-butane); PVA (polyvinyl alcohol); acrylic; polyethylene; and polyether imide, for example. The aforementioned nanocarbon molecules, for example, may be employed as the electron transport molecules. The amount of nanocarbon molecules to be doped in the insulator may be within a range of 5 wt % to 35 wt %, and the thickness of the electron transport layer 5 is preferably within a range of 0.05 μm to 0.5 μm. It is preferable for the conductivity of the electron transport layer 23 to be within a range of 10¹¹ Ω·cm to 10¹³ Ω·cm.

The second electrode layer 24 is constituted by an active matrix substrate, in which a great number of pixel portions 27 are arranged two dimensionally. Collecting electrodes 25 are provided to detect signals corresponding to electric charges generated in the photoconductive layer 22. Each pixel portion 27 is constituted by: a collecting electrode 25; an accumulating capacitor 28, for accumulating the charges collected by the collecting electrode 25; a switching element 26, for reading out the charges accumulated in the accumulating capacitor 28; a great number of scanning lines 29, for turning the switching element 26 ON/OFF; and a great number of data lines 30, for reading out the charges accumulated in the accumulating capacitor 28.

The collecting electrodes 25 are 0.05 μm to 1 μm thick films made of Al, Au, Cr, ITO (Indium Tin Oxide), IZO (Indium Zinc Oxide) or the like.

Commonly, a-Si TFT's having amorphous silicon as active layers are used as the switching elements 26. A scanning line 29 for turning each of the switching element 26 ON and OFF is connected to a gate electrode thereof. A data line 30 for reading out the charges accumulated in the accumulating capacitor 28 is connected to the source electrode of each switching element 26. An accumulating capacitor electrode 31, which is one of two electrodes that constitute an accumulating capacitor 28, is connected to the drain electrode of each of the switching elements 26. An amplifier 32 is connected to the end of the data line 30 opposite that which is connected to the source electrode of each switching element 26. The other of the two electrodes that constitute an accumulating capacitor 28 is connected to an accumulating capacitor wire 33.

Next, an example of the operation of the radiation image detector 20 will be described. The high voltage source applies a negative biasing voltage to the first electrode layer 21 of the radiation image detector 20, to form an electrical field between the first electrode layer 21 and the collecting electrodes 25. Radiation is irradiated from a radiation source, such as an X-ray source, onto a subject in this state. The radiation, which has passed through the subject and bears a radiation image thereof, is irradiated onto the radiation image detector 20 from the side of the first electrode layer 21.

The radiation passes through the first electrode layer 1 and is irradiated onto the photoconductive layer 22. Thereby, charge pairs corresponding to the amount of radiation are generated in the photoconductive layer 22. Among the generated charge pairs, positive electric charges (positive holes) move toward the first electrode layer 21, combine with the negative charges which have been injected by the high voltage source, and disappear.

Meanwhile, negative electric charges (electrons) from among the generated charge pairs move toward the collecting electrodes 25 along the electrical field distribution formed by the application of the biasing voltage. The electrons are collected by the collecting electrodes 25, and accumulated in the accumulating capacitors 28, which are electrically connected to the collecting electrodes 25. The photoconductive layer 22 generates electric charges in an amount corresponding to the dosage of irradiated radiation. Therefore, electric charges corresponding to image data borne by the radiation are accumulated in the accumulating capacitor 28 of each pixel portion 27.

If high dosage radiation is irradiated at this time, negative charges become trapped among the collecting electrodes 25, thereby causing image density fluctuations to appear, in radiation image detectors which do not have the electron transport layer 23, or in radiation image detectors which merely have an insulating layer instead of the electron transport layer 23. However, the radiation image detector 20 of the present embodiment is equipped with the electron transport layer 23 having the construction described above. Accordingly, trapping of negative charges is reduced, and the occurrence of image density fluctuations can be suppressed.

When the radiation image which has been recorded on the radiation image detector 20 is read out, signals for turning the switching elements 33 ON are sequentially input via the scanning lines 29, and the electric charges accumulated in the accumulating capacitors 28 are taken out via the data lines 30. The amplifiers 32 detect the amount of electrical charges for each pixel, to read out image data.

The radiation image detector 20 of the second embodiment is also provided with the electron transport layer 23. Therefore, trapping of electric charges and the occurrence of image density fluctuations can be suppressed, similar to the radiation image detector 10 of the first embodiment.

The aforementioned trapping of electric charges occurs at non electrode portions. Therefore, the amount of trapped electric charges becomes greater as the open area ratio becomes smaller. Here, the open area ratio of radiation image detectors that employ the optical readout method is as explained previously. The open area ratio of radiation image detectors that use the electrical readout method is the ratio of the area of the collecting electrodes with respect to the area of a single pixel portion. Commonly, the minimum line width of the radiation image detectors that use the electrical readout method is uniform, due to the limitations of manufacturing apparatuses therefor. The open area ratio decreases as the sizes of the pixel portions becomes smaller, because areas occupied by other capacitors and the like are necessary. That is, as the pixel portions become smaller, the area of the surface of the detector which is not covered by electrodes (conductors) drastically increases, leading to an increase in the amount of trapped electrical charges and conspicuous image density fluctuations.

In the case of the radiation image detector 10, which uses the optical readout method, the minimum widths of the linear electrodes and the gaps between the electrodes are also limited due to limitations of the manufacturing process. Specifically, the minimum widths of the linear electrodes and the gaps therebetween are approximately 10 μm. In Example 1 and Example 2 described above, the pixels are provided at a pitch of 50 μm, and the width ratio of the first linear electrodes 6a and the second linear electrodes 6b is 10 μm:20 μm. Therefore, the open area ratio is 60%. However, if the pixel pitch is set to 40 μm, the width ratio of the first linear electrodes 6a and the second linear electrodes 6b will become 10 μm:10 μm, due to the above limitation, and the open area ratio will become 50%. Accordingly, as the pixel portions become smaller, the area of the surface of the detector which is not covered by electrodes (conductors) drastically increases, leading to an increase in the amount of trapped electrical charges and conspicuous image density fluctuations in radiation image detectors that use the optical readout method as well.

Recently, the miniaturization of pixel portions is progressing. If the electron transport layer of the present invention is provided in a radiation image detector having a small pixel size, such as 50 μm-50 μm pixel portions, and an open area ratio of 0.6, trapping of electric charges can be reduced, and image density fluctuations can be effectively suppressed.

Note that the layer structure of the radiation image detector of the present invention is not limited to those of the embodiments described above. The radiation image detector of the present invention may be provided with additional layers.

What is claimed is:

1. A radiation image detector, comprising:
a first electrode layer, to which negative voltage is applied, and that transmits recording electromagnetic waves bearing radiation image information;
a photoconductive layer that generates charges when irradiated by the recording electromagnetic waves transmitted through the first electrode layer;
a second electrode layer provided at the side of the photoconductive layer opposite that of the first electrode layer, having a plurality of electrodes for detecting signals corresponding to the charges generated in the photoconductive layer; and
an electron transport layer provided between the photoconductive layer and the second electrode layer so as to cover the entire surface of the second electrode layer, formed by an insulating material doped with electron transport molecules.

2. A radiation image detector as defined in claim 1, further comprising:
a readout photoconductive layer provided between the photoconductive layer and the second electrode layer that generates charges when irradiated by readout light.

3. A radiation image detector as defined in claim 1, wherein:
the electrodes of the second electrode layer collect the charges which are generated in the photoconductive layer; and
the second electrode layer is further equipped with integrating capacitors for accumulating the charges collected by the electrodes, and switching elements for reading out the charges accumulated within the integrating capacitors.

4. A radiation image detector as defined in claim 1, wherein:
the electron transport molecules are nanocarbon molecules.

5. A radiation image detector as defined in claim 4, further comprising:
a readout photoconductive layer provided between the photoconductive layer and the second electrode layer that generates charges when irradiated by readout light.

6. A radiation image detector as defined in claim 4, wherein:
the electrodes of the second electrode layer collect the charges which are generated in the photoconductive layer; and
the second electrode layer is further equipped with integrating capacitors for accumulating the charges collected by the electrodes, and switching elements for reading out the charges accumulated within the integrating capacitors.
